(19) United States
(12) Patent Application Publication
(10) Pub. No.: US 2015/0052042 A1
(43) Pub. Date: Feb. 19, 2015

(54) METHOD, SYSTEM, SERVICE, AND COMPUTER PROGRAM PRODUCT FOR VERIFICATION AND DELIVERY OF A BORROWER'S ASSETS AND DEPOSITS INFORMATION

(71) Applicant: PointServ, Inc., Burlingame, CA (US)

(72) Inventors: Iavor BOYANOV, Burlingame, CA (US); Iordan GAVAZOV, San Carlos, CA (US)

(73) Assignee: PointServ, Inc., Burlingame, CA (US)

(21) Appl. No.: 14/198,347

(22) Filed: Mar. 5, 2014

Related U.S. Application Data
(63) Continuation-in-part of application No. 14/150,581, filed on Jan. 8, 2014.
Application No. 14/150,581 is a continuation-in-part of application No. 14/103,455, filed on Dec. 11, 2013.
(60) Provisional application No. 61/865,446, filed on Aug. 13, 2013.

(51) Int. Cl. G06Q 40/02

(52) U.S. Cl. CPC G06Q 40/025
USPC 705/38

(57) ABSTRACT

A technique of assets and deposits verification for making a lending decision is disclosed that does not require requesting manual assets and deposits verification and performing a manual comparison of the results of such verification to financial statements provided by the borrower. The borrower provides authentication information (e.g., login credentials), which a verification service utilizes to obtain the borrower's assets and deposits information from a financial institution. The verification service delivers verified assets and deposits data and financial statements to the lender, which can be provided securely in a tamper proof form. Techniques to provide privacy protection for the borrower may include a privacy protection protocol. Additionally, a certificate of authenticity may be provided to the lender.

### CROSS-REFERENCE TO RELATED APPLICATIONS

This application is a continuation-in-part of U.S. patent application Ser. No. 14/150,581, filed on Jan. 8, 2014, which is a continuation-in-part of U.S. patent application Ser. No. 14/103,455, filed on Dec. 11, 2013, which claims the benefit of priority under U.S.C. §119(e) to U.S. Provisional Patent Application No. 61/865,446, filed on Aug. 13, 2013, all of which are incorporated herein by reference in their entirety for all purposes.

### BACKGROUND OF THE INVENTION

1. The Field of the Invention

The invention relates to a method, system, service, and computer program product for confirming the authenticity of bank statements or other financial institution statements (collectively “Financial Statements”; and “Financial Statement” means any of them) by obtaining the statement, and information about it, from trustable sources such as the financial institution that issued it (“Financial Institutions”). Financial Institutions offer computer programs that their customers can use to access their financial statements electronically. Many of these institutions offer their software as a service through a website accessible over the Internet.

2. Existing Process Used Throughout the U.S. Mortgage Industry to Verify Assets and Income Information

In applying for a loan (e.g., home mortgage), a borrower is required to fill out various forms for the lender, and also provide evidence of the borrower's ability to pay back the loan. This includes providing proof of the borrower's income and assets. One form of information that is normally required of the borrower is a copy of the borrower's financial statements in order to perform a check of the borrower's assets and deposits.

However, financial statements provided by a borrower could be incorrect or falsified. To provide a safeguard against potential mortgage fraud, it is an industry-wide practice to also verify the information contained within the financial statement. For example, companies such as Billing Solutions, Inc of Wayne Ill., offer verification of assets, typically within about 2 business days. This time delay is associated with both the time required for the verification service to obtain the information from the financial institution and any additional time required by the verification service to perform additional manual checking.

This verification process follows a de facto industry standard in that it is the practice of major government backed lending programs (Fannie Mae and Freddie Mac programs), and also major banks and other lending institutions. In particular, in the prior art, the borrower is required to execute an authorization form (authorizing the lender to request information from the borrower's financial institution), and then a contact is made with the appropriate financial institution to verify the information contained within the financial statement. However, this industry standard process is very inefficient.

FIG. 1 sets forth the prior art process. Currently, any person or an institution interested in obtaining a verified copy of a financial statement (“Interested Party”) of another person must follow a tedious and time consuming process to do so (FIG. 1). The prior art process includes multiple steps that must be performed by a borrower 105, a lender 110, a third party vendor 115, and the financial institution 120. We now discuss the major steps from the standpoint of an interested party (typically the lender or someone associated with the lending process). The financial institution was historically a bank. However, more generally it may be any financial institution in which a user receives financial statements for their assets and deposits. Examples include savings accounts, checking accounts, and other types of accounts in which individuals make deposits. (While the total assets in the account are of interest to a lender, other types of information on deposit activity and changes in the account balance may also be of interest in fraud detection.)

First, the interested party must obtain a copy of the financial statement from the borrower. That step in itself could be difficult and time consuming in some instances as the borrower must first locate a copy of the financial statement, and then submit it to the interested party.

As a second step, the interested party must obtain consent from the borrower that authorizes the appropriate financial institution to release data about the financial statement to the interested party. For example, to authorize a financial institution to release information about a financial statement for a prospective borrower, the borrower will be required by the lender to sign a “Borrower's Certification and Authorization Form.”

The next step in the process would be for the interested party to contact and request the necessary data from the financial institution. This can be done directly, but in most cases, it is done through a third party vendor company that specializes in processing such requests. This step may take many days to complete, for example, in the case of obtaining assets and deposits information, the typical turnaround time is two business days. Additionally, financial institutions have strict cutoff times, which can mean that if a prospective borrower begins the paperwork before a holiday weekend, the information may not arrive for many days.

Finally, once data is returned back from the financial institution, the interested party must spend time and resources to reconcile that data to the financial statement provided by the borrower in order to ensure its authenticity. This manual step can also be performed, in some cases, by a third party vendor.

Now consider the steps from the standpoint of a legitimate borrower. The legitimate borrow has to find their financial statement and provide a copy to the interested party. This itself can be a burden if the user is providing a hardcopy, as the user must find and copy the financial statement. If a softcopy is provided by email, the borrower's confidential information might be compromised. Additionally, the borrower must execute and sign the authorization form and return either a hardcopy or a softcopy of the signed form. Additionally, the legitimate borrower may be in a hurry to go house hunting. The fact that the traditional process takes several days to complete can be frustrating to a legitimate borrower with a tight schedule.

Thus, the existing process is very tedious and time consuming as it requires manual actions from each party involved—the borrower must look for a copy of the financial statement, and must find a way to submit it to the interested party, the interested party or its third party representative must obtain and validate the borrower's consent form, the financial institution must validate and process the request for assets and deposits information, and finally the interested party must reconcile the assets and deposits information against the financial statement provided by the borrower.

Therefore, the present invention was developed to address the drawbacks of the prior art approach.

### SUMMARY OF THE INVENTION

Having a borrower provide financial statements to verify their assets and deposits to a mortgage lender suffers from the problem that a borrower might deliberately submit fake, incorrect, or falsified financial statements. Thus, most lenders do not rely solely on financial statements submitted by a borrower. Additional anti-fraud measures are required to reduce the risk of mortgage fraud.

The de facto standard in the mortgage loan industry used to verify assets and deposits of borrowers is inefficient and typically requires several days to complete and requires steps such as requesting financial information from the financial institution and performing a manual comparison between the financial information and copies of financial statements provided by a borrower. Additionally, in the prior art a legitimate borrower has the burden of providing copies of their financial statements, signing and returning an authorization form, and waiting days for the process to complete. Additionally, there is a potential privacy concerns for a legitimate borrower.

To overcome these limitations, it is therefore an object of the present invention to provide a fast, convenient process to obtain a verified copy of assets and deposits information, which may include a verified copy of a financial statement and/or a verified summary of relevant financial statement information, such as an assets and deposits verification. In accordance with the invention, needless steps from the existing process used in the mortgage loan industry are eliminated and the time required for verifying assets and deposits information is significantly reduced.

The present invention provides a paradigm shift in the mortgage industry for verifying assets and deposits. The inventors have recognized that many borrowers access their financial statements on their financial institution's website. The records of the financial institution can be accessed by a trusted verification service and additional layers of checking, security, and tamper proofing can be provided in order to deliver verified assets and deposits information to a lender. To achieve the objects of the invention, in one embodiment, there is provided a method for a trusted verification service to access a borrower's financial statement information from a financial institution. The end product is a verified financial statement, meaning a copy of a financial statement that is verified to be authentic by the nature of the source from where it was obtained—i.e., it is based on information retrieved from the financial institution and thus protects against common forms of fraud seen in the mortgage industry in which a borrower submits falsified financial statements. Additional security protection can be included, such as providing the financial statement information in a tamper-proof file and using secure communications between the verification service and lender.

Moreover, the present invention provides convenience and privacy protection to legitimate borrowers. The legitimate borrower does not have to submit financial statements in addition to filing out and submitting an authorization form. The borrower saves time in the loan process. Additionally, the legitimate borrower does not have to submit financial statements via insecure email connections. Features are preferably included to provide a high level of privacy and security for the borrower's confidential information.

An exemplary method comprises the steps of a trusted verification service receiving the borrower's data and consent and obtaining a financial statement directly from a financial institution over the Internet. The process may be triggered by a request from a lender, resulting in the borrower being provided with a link or a user interface to enter the data and consent. The borrower is not involved in accessing the financial statement such that the borrower is prevented from tampering with and falsifying the financial statement. Additional privacy and security protection may be provided by securely providing the assets and deposits information to the lender in a tamper-proof file. A certificate of authenticity may also be generated for the lender.

An exemplary system for implementing the method is a computer based system having one or more servers and interfaces. The system may be implemented as a third party service aiding lenders. However, more generally the system may also be implemented by other parties, such as by a financial institution or by a lender.

### BRIEF DESCRIPTION OF THE DRAWINGS

FIG. 1 provides an example of how the de facto industry standard process works when verifying the authenticity of a financial statement for a mortgage lender in accordance with the prior art.

FIG. 2A illustrates a method for providing assets and deposits verification in accordance with an embodiment of the present invention.

FIG. 2B illustrates a method for verifying the authenticity of a financial statement in accordance with an embodiment of the present invention.

FIG. 3 compares the process examples outlined in FIG. 1 and FIG. 2B.

FIG. 4 is a system view of the process that takes place when utilizing the present invention, outlining the software modules that are involved in a typical use example in accordance with an embodiment of the present invention.

FIG. 5 illustrates an embodiment of a system in which the system is implemented by a lender in accordance with an embodiment of the present invention.

FIG. 6 illustrates an embodiment of a system in which a system verifies a financial statement received from a lender in accordance with an embodiment of the present invention.

FIG. 7 illustrates an embodiment of a system in which a financial institution verifies financial statement information in accordance with an embodiment of the present invention.

### DETAILED DESCRIPTION

A fast and convenient computer-implemented process for a trusted verification service to provide a verified copy of a financial statement is disclosed. Additionally, the process can be used to obtain a verified summary of assets and deposits. The process is applicable to the large percentage of borrowers that directly or indirectly have access to electronic financial statements.

Many borrowers use a financial institution website to electronically access their financial statements. One aspect of the invention is the recognition by the inventors that a large percentage of prospective borrowers have access to electronic financial documents through their financial institutions.

Another aspect of the invention is the recognition that the financial institutions maintain financial statements for their customers. This information from the financial institutions is thus a potential source of information for many individuals.

Yet another aspect of the invention is the recognition by the inventors that the information stored by financial institutions may be acquired and used to obtain verified assets and deposits information for prospective borrowers seeking a loan.

The trusted verification service implements the processes via software modules running on a computer system having at least one processor and a memory, as well as any necessary database systems, security mechanisms, servers, and interfaces. The software modules may, in turn, be stored or sold as computer instructions stored on a non-transitory computer readable medium.

Trust is an important part of the verification. The lender needs to trust that the information is valid and not tampered with. Additionally, borrowers need to have trust that their private information is secure. Depending on implementation, additional server support, including web servers, may be provided to access information over the Internet and maintain privacy and security of assets and deposits records. To support privacy and tamper-proofing, software and hardware to support privacy and security are also preferably included. Additional trust measures, such as generating certificates of authenticity, may also be employed.

No prior art manual processes exist that are comparable to the present invention. The present invention describes a new paradigm for the mortgage loan industry. Consequently, it will be understood that a computer system implementing any of the methods of the present invention functions as a specially programmed (special purpose) computer.

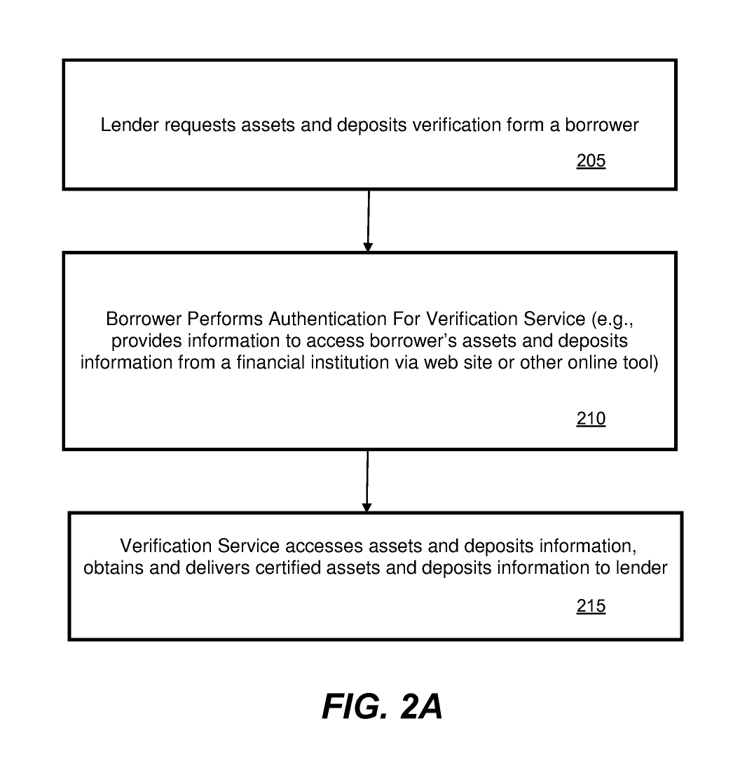

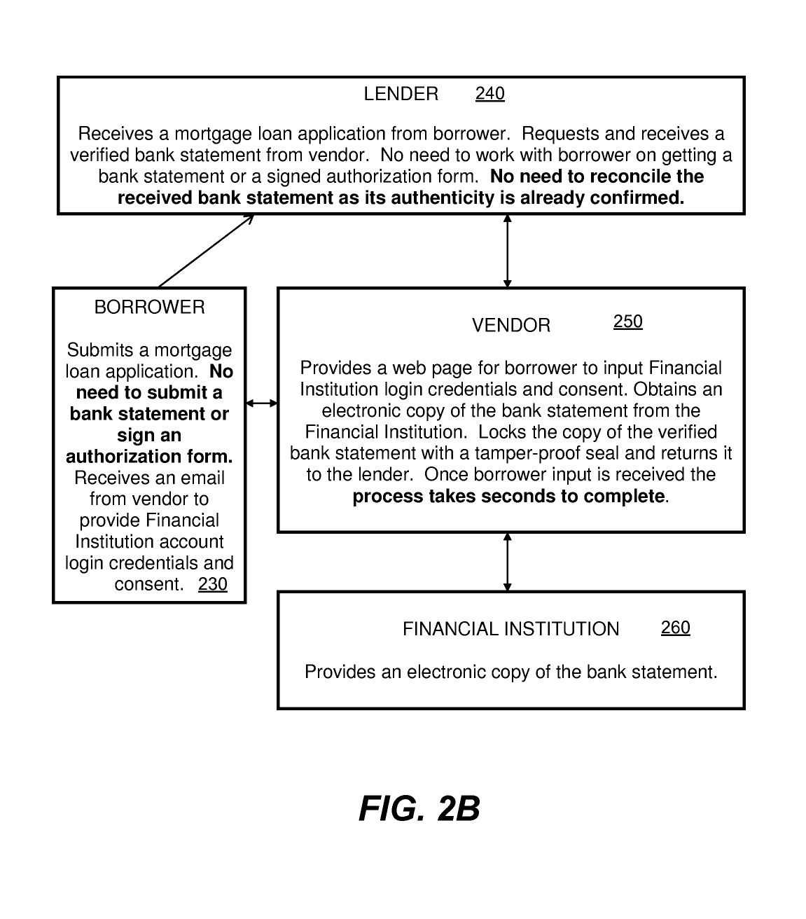

FIG. 2A illustrates a sequence of actions between a lender, a borrower, and a service provider in accordance with an embodiment of the present invention. A lender requests assets and deposits verification from a borrower (step 205). The borrower then performs an authentication step for the trusted verification service (block 210). The authentication step includes the borrower providing sufficient information for the trusted verification service to access the borrower's financial records from a financial institution. This includes any login credentials, the identity of the financial institution, and any other information required to login and accesses the financial records of the borrower, which typically would include at least a user name and password. The borrower also provides any necessary consent required by law or by the terms of the financial institution.

The verification service then accesses financial information from the financial institution (block 215). The verification service then generates and delivers verified assets and deposits data and/or a verified financial statement to a lender. The information may be provided to the lender with a certification of authenticity and be provided in a tamper proof document.

FIG. 2B illustrates a sequence of actions between a borrower, a lender, an assets and deposits verification vendor, and a financial institution, showing in more detail an exemplary sequence of actions. A borrower 230 submits a loan application to a lender 240. In this example, the lender requests the trusted verification service 250 to provide verified financial statement information. In one embodiment the trusted verification service 250 operates as a third party vendor. For example, the third party vendor may operate as a web-based service providing services to the lending industry.

The trusted verification service 250, in turn, provides a web-page for the borrower 230 to input information sufficient to contact the financial institution and access the borrower's financial records. The trusted verification service 250 then contacts the financial institution 260 and receives, in return, a copy of an electronic financial statement of the borrower.

The trusted verification service then has several different options. First, it can provide a verified financial statement in a tamper proof form to the lender. Secondly, if desired, summary information may be generated and provided to the lender.

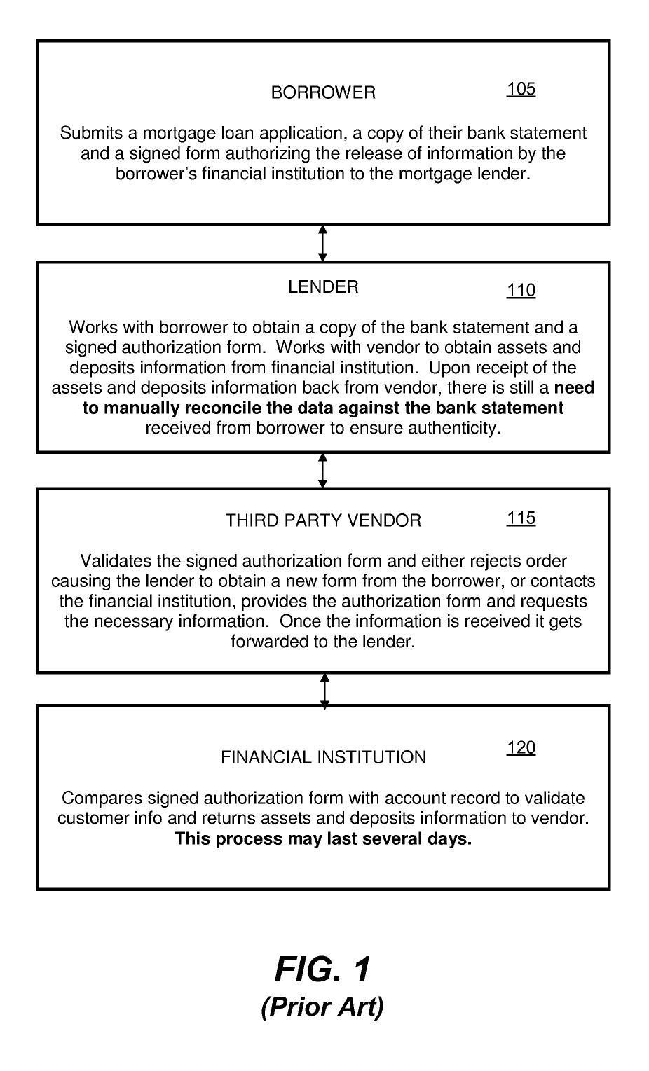

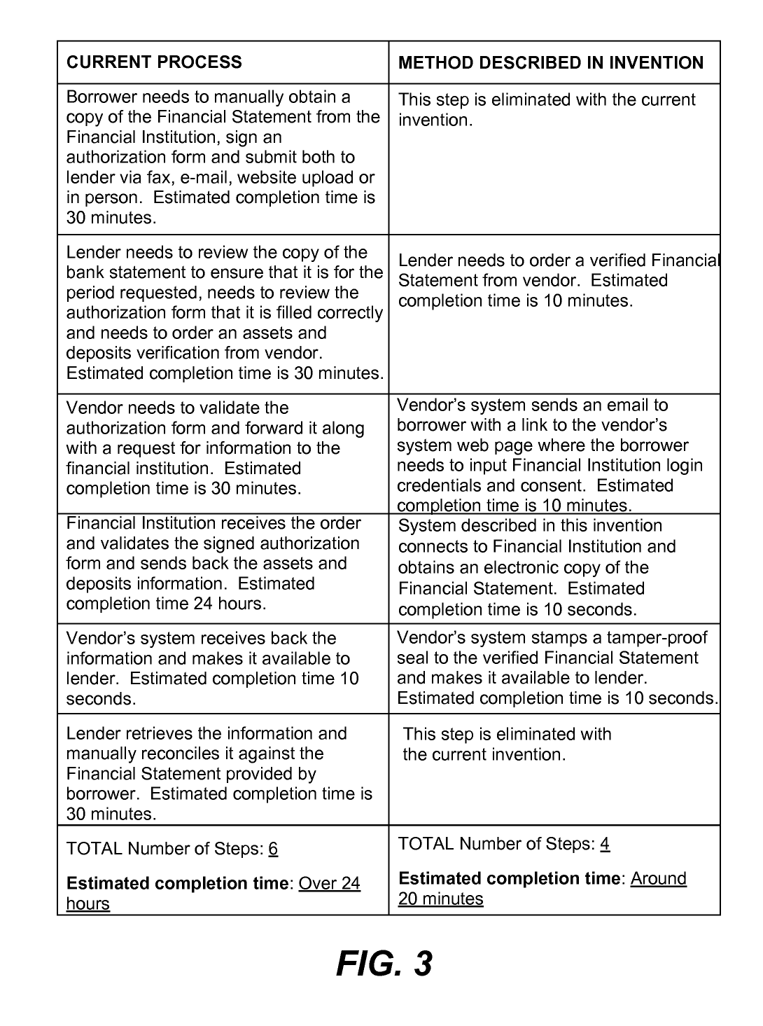

FIG. 3 illustrates a comparison of the method of FIG. 2B with the prior art method of FIG. 1. The estimated completion time for the prior art method is over 50 hours. In contrast, the estimated completion time for the method of FIG. 2B can be as little as 20 minutes or better, depending on factors such as Internet speed and access time at a financial institution. Thus, the present invention provides a dramatic improvement and saves time and effort, making the loan application process easier and more efficient.

The advantage to both the borrower and the lender are substantial given the nature of the mortgage loan industry. Borrowers are often in a rush to search for a house, and saving several days of time to obtain a loan can provide a huge benefit. Additionally, both the borrower and the lender benefit from the improved efficiency of the system. Additionally, legitimate borrowers benefit from improved convenience and privacy protection.

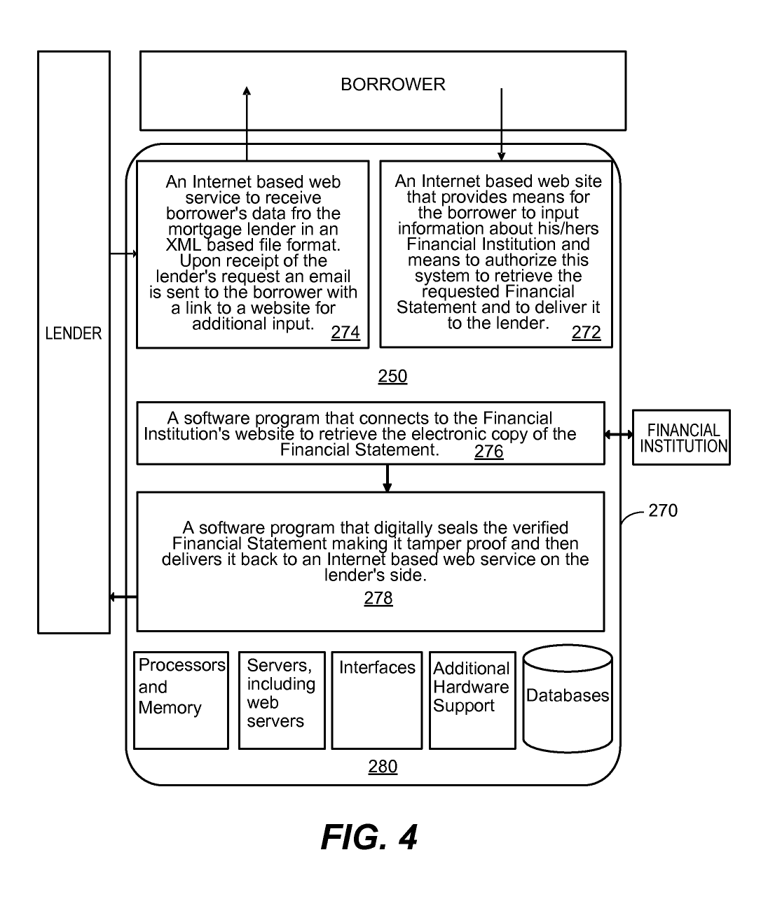

FIG. 4 illustrates an exemplary system to provide a trusted verification service 250 in accordance with an embodiment of the present invention. The system may be implemented as a computer system that includes both hardware and software components, such as a computer system, having one or more servers, computer processors, memory, and databases, with software modules stored on a computer readable medium. For the purposes of illustration, the trusted verification service 250 is conceptually divided into a hardware/support section 280 and a software system 270 for retrieving and delivery of a verified financial statement. The hardware/support section 280 includes processors, memory, servers, interfaces, databases, and any additional hardware support.

The software system 270 of FIG. 4 includes an exemplary set of software modules and services for the purposes of illustration, although it will be understood that variations on what is illustrated are within the scope of the present invention. The software modules are stored on a non-transitory computer readable medium and execute on the hardware/support section 280.

In one embodiment a software module 272 receives information about the borrower sufficient to access the borrower's assets and deposits information from a financial institution. This may include names, dates of birth, social security number, financial institution information and user account login credentials. Additionally, it could include equivalent information, such as account ID information. Moreover, it may include whatever consent information or consent forms are required by a financial institution and any relevant state, local, and national privacy and consent laws to authorize the financial institution to provide the borrower's assets and deposits information to an assets and deposits verification service. The software module 272 could be implemented in several forms depending on the needs of the software system user. An exemplary embodiment includes an Internet based web service that receives the data and any additional information and/or documents in an XML format (or other format that can be processed); an Internet based web page that provides a form for a user to input the necessary data and to upload any applicable documents; and any other software interface that allows the system to receive the data and any additional information and/or documents either as a manual user input or in a specific file format.

In one embodiment a software module 274 processes the data and sends an email to the borrower with a link to a website where the borrower can provide his/hers financial institution account login information and an authorization to allow the system to retrieve an electronic financial statement from the financial institution. This module 274, including email and a website, is only necessary if the login information and authorization requested from the borrower have not been provided by other means.

In one embodiment a software module 276 connects to the financial institution to retrieve the financial statement. This module 276 could be implemented in several forms depending on the available functionality of the financial institution's software systems, including:
1) A request to an Internet based web service that is made available by the financial institution. Such request can be in an XML file format or any other file format as requested by the financial institution and it can include information about the borrower and the requested financial statement as well as any additional information and/or documents requested by the financial institution. The financial institution can return the financial statement in a PDF file format, or any other file format as determined by the financial institution. The financial statement file can be returned either in its raw form or it could be encapsulated in an XML file format, or any other file format as determined by the financial institution. The financial statement could be returned synchronously, meaning that the web service made available by the financial institution will respond to the initial request made by the system as part of the same session, or asynchronously, meaning that the response by the web service will be part of a different session. An asynchronous response may be triggered by the financial institution as a push to a web service listening on the end of the module described herein, or it could be in a response in a sub-sequent request to the financial institution's web service that inquires about the status of the initial request.
2) A software program that will act as a web browser on behalf of the borrower. Such program will automate the tasks of connecting to the financial institution website, login in to that website as the borrower, navigating through the website links and pages, and retrieving the financial statement in the format made available by the financial institution on the website.
3) Any other means provided by the financial institution to connect and retrieve the financial statement.

In one embodiment a software module 278 packages and delivers the verified financial statement to the interested party. In one embodiment, additional security measures are employed to prevent tampering. In one embodiment, this module will place a digital tamper-proof stamp on the financial statement and will make it available to the interested party by means specified by that party. For example, a tamper-proof stamp or security code could be placed on a PDF file of the verified financial statement. The module 278 is optional and it could be implemented in a variety of ways as deemed necessary by the interesting party.

### USE EXAMPLES AND ALTERNATE EMBODIMENTS FOR THE INVENTION TO AUTHENTICATE FINANCIAL STATEMENTS, VALIDATE EXISTING FINANCIAL STATEMENT, AND AUTHENTICATE ASSETS AND DEPOSITS

It will be understood that the functionality of the invention may be implemented in different ways. In particular, it will be understood that different parties may implement features of the present invention. As examples, the functionality may be implemented by a third party vendor, by a financial institution, and also integrated with a lender's service.

### Use Example 1

Referring to FIG. 4, in this example, a third party vendor provides the trusted verification service and delivers authenticated financial statements for lenders or other interested parties by getting a copy of these documents directly from financial institutions.

A mortgage lender is required to obtain a financial statement from a loan applicant and to validate the authenticity of that document for fraud prevention. To do so, they send an order to a third party vendor and provide basic information about the loan applicant, including names, social security number and email address. Upon receiving the order, the third party vendor sends an email to the loan applicant with a link to an Internet web page. On the web page, the loan applicant specifies what financial institution is used to access the financial statement and inputs the login credentials for his/hers online account with that financial institution. The loan applicant also checks a box to authorize the third party vendor to obtain a copy of the financial statement and to forward it to the mortgage lender. Upon receiving the information from the loan applicant, the third party vendor's system automatically connects to the financial institution's website by using the loan applicant's login credentials and it retrieves a copy of the financial statement. The system then seals the verified copy of the financial statement, making it tamper-proof, and forwards it to the mortgage lender. Although processing times may vary depending on network conditions and other factors, the process can complete as fast as a few seconds once the loan applicant has provided login credentials and consent. There is no need for the loan applicant to manually pull the financial statement and to forward it to the lender, and no need for the lender to reconcile the financial statement as its authenticity is guaranteed by the method by which it was obtained.

### Additional Use Example 2

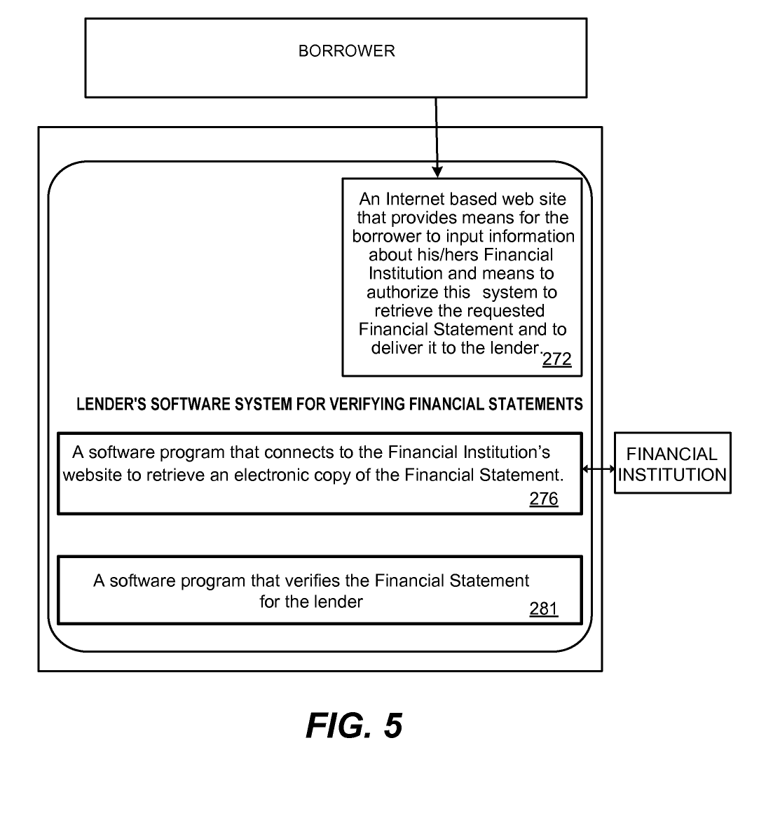

It will be understood that a large lender could also implement the verification service. As such, the lender would implement most of the modules of FIG. 4, with minor modifications, such as a software program 281 that verifies the financial statement for the lender. Depending on implementation, some features, such creating a tamper-proof copy, may be less important due to the fact that the lender is implementing the service. FIG. 5 illustrates an example set of software modules that a lender could implement to provide the service for themselves (hardware omitted for clarity). Referring to FIG. 5, in this example, a lender or an interested party gets an authenticated financial statement directly from a financial institution. A mortgage lender can decide not to use a third party vendor to obtain a verified financial statement as outlined in the typical use example above. In that scenario, the mortgage lender implements a system to obtain login credentials from the loan applicant and to connect to the financial institution's website in order to obtain the financial statement.

### Additional Use Example 3

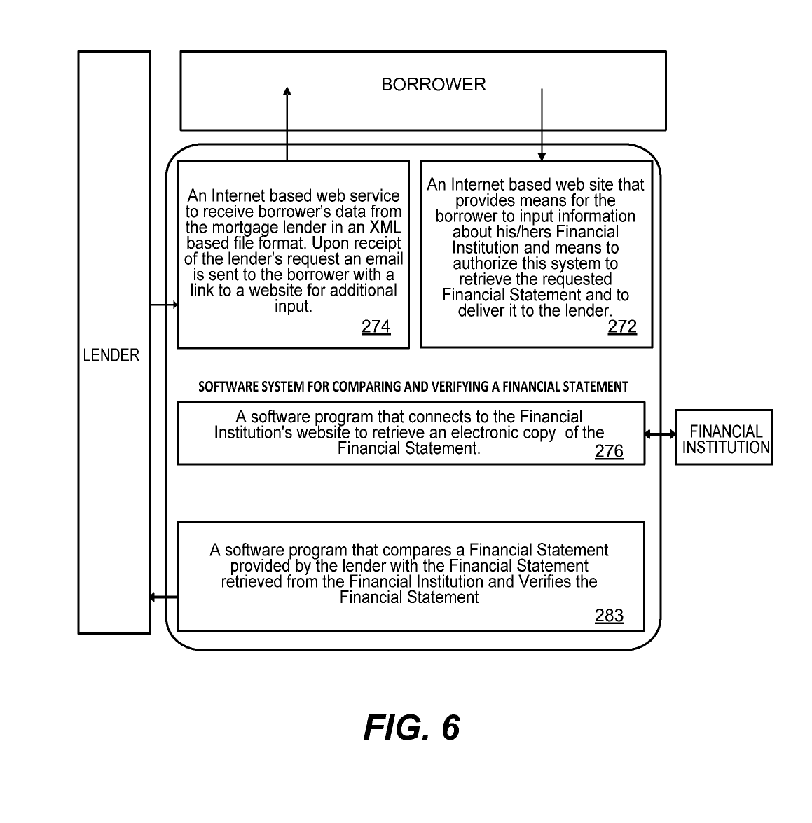

Referring to FIG. 6, in this example, a third party vendor offers a service to authenticate a financial statement provided by a lender or an interested party by comparing it against a financial statement retrieved from a financial institution. In this example, the method is used to retrieve the financial statement from the financial institution, but the financial statement is only used for comparison and it is not being delivered to the lender. Instead of delivering a verified financial statement, as outlined in the typical use example above, a third party vendor may offer a service to validate an existing copy of the financial statement. In that scenario, the mortgage lender sends a copy of the financial statement along with the rest of the information. The vendor implements a system to obtain the login credentials from the loan applicant and to connect to the financial institution's website to obtain the verified financial statement. The vendor then reconciles the mortgage lender's copy of the financial statement against the verified copy of the financial statement and reports its findings to the mortgage lender. Module 283 supports comparing the financial statement received from the lender with that obtained from the financial institution.

### Additional Use Example 4

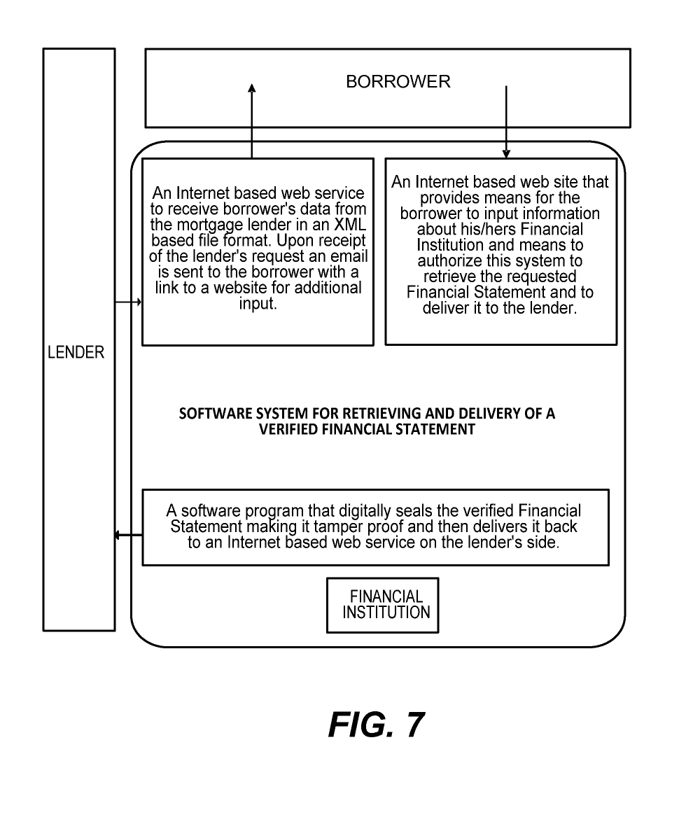

In one embodiment a financial institution implements the trusted verification service. Referring to FIG. 7, in this example a financial institution 251 offers a service to lenders and interested parties to provide them with an authenticated financial statement.

### Alternate Embodiments to Re-Check Assets and Deposits Information

In a typical use scenario the financial statement information is verified once. However, it will be understood that once the verification service has performed an initial verification that the process may be repeated, if desired, during the loan process. For example, in many home buying scenarios a borrower is initially qualified and the lender provides a guarantee for a range of loan amounts. The borrower then goes about searching for a home and on closing negotiations on the home, after which the house goes through escrow and closing. The entire process might take many weeks and thus extend over a payroll date. Additionally, in some situations the borrower's financial information may change during the home-hunting process. Thus, if desired, the user's consent to re-verify the assets and deposits information may be requested and the verification service would then perform a second assets and deposits verification step.

### Additional Alternate Embodiments of the Invention to Generate a Verified Summary of a Subset of Assets and Deposits Information

It will also be understood that individual fields of a financial statement may also be verified to generate a verified summary, such as those particular fields relevant to a lender or to others interested in the financial resources of an applicant.

Additionally, the assets and deposits information may be processed and provided to the lender in the form of assets and deposits checks and alerts.

For example, a mortgage lender may desire to receive a verified summary of the most relevant information related to the ability to payback a loan. The summary could be in addition to the complete verified financial statement or as an alternative.

Alternatively, it will be understood that the summary may be provided in areas outside of traditional home mortgage lending, such as a summary for obtaining other types of loans or as evidence of credit worthiness in other contexts, such as rentals.

### Additional Security and Privacy Implementation Examples

It will be understood that state-of-the art web security technology is preferably used. An exemplary system, implemented in 2013, includes services hosted at a Statement of Auditing Standards (SAS) 70 type II Certified facility. Web communications and data transmissions may be implemented with as Secure Socket Layer (SSL) based communications utilizing 128 bit encryption or better. More generally, the data security and privacy implementation may be implemented in accordance with the recommendations and requirements of government agencies and any relevant industry associations.

In one embodiment, a certificate of authenticity and an action log is provided to the lender. The certificate of authenticity provides an additional measure of trust to a lender. The certificate of authenticity, if used, is implemented to demonstrate that the assets and deposits information is coming from the trusted verification service. The certificate may be implemented, for example, using the approaches taken in ecommerce and finance areas to verify links, websites, and sources of products. As examples, the certificate may take the form of a digital certificate or digital signature; alternatively it may take the form of a digital watermark or a visual code.

From the perspective of the lender, proving the assets and deposits information in a tamper-proof form is a measure that aids in preventing fraud. While examples of tamper-proofing have been described, it will be understood that the assets and deposits information may be provided using other tamper-proofing techniques that may be developed in the future.

As previously discussed, the verification services requires connecting with the borrower's financial institution (the Financial Institution). This, in turn, requires the service to access the borrower's online account with that institution. In one embodiment the verification services requests the user name, password and any other login information that the borrower has setup up with that institution to enable access.

Borrowers may have privacy concerns about providing their login credentials, given the large amounts of private information associated with their financial statements. Thus, it is desirable to provide privacy protections measures for the borrower while also facilitating ease of use for the borrower.

Moreover, some borrowers may have concerns about the safety of their deposits if they provide the login credentials. That is, borrowers may worry about the use of such information by malicious third parties. Thus, privacy protection is important to provide a borrower with peace of mind that their assets will remain secure if they provide the login credential to an account at a financial institution.

The login credentials are used to download financial statements and other information used in providing the verification services. Additionally, the login credential may be required for additional time periods to address errors or service interruptions in the download process. Storing the borrower's login credentials may be performed on a temporary basis to deal with issues such as service interruptions and error issues. However, it may also be useful to store the login credentials to make it easier for the borrower to reapply for a loan at a later time, or for other reasons.

A privacy protection protocol is preferably implemented. A retention policy defining how long and under what privacy protection conditions the login credentials are stored may be implemented. The borrower is preferably informed about the privacy protection policy.

If the verification service stores the borrower's login credentials, it preferably maintains and encrypts them on firewall-protected servers. This login information is encrypted and transmitted using secure socket layer technology, making it unreadable during transmission. It is then stored on secure servers.

Additional techniques may be employed to authenticate to the borrower that the user interfaces are secure. That is, the borrower may be provided with an indication or indicators to verify that the user interface is not a spamming attempt by a malicious party. In the case of the link/user interface being triggered in response to a request from a lender, information about the lender, a loan application ID, or other information may be provided. Any technique utilized in ecommerce and online finance to indicate that a site or a link is a trusted site/link may also be utilized to aid a borrower in understanding that the link/user interface is genuine and not a spamming attempt. Consequently, it will be understood that the process flows may be varied from those describe above to include additional security and/or assurance to the borrower that the user interface is genuine and that the borrower's confidential information will be given a high level of privacy protection.

While the convenience of the borrower is an important consideration, there may be a subset of borrowers that prefer to directly login to the trusted verification service rather than use a link sent to them. Additionally, a borrower could pre-register with a trusted verification service prior to applying for a loan. It will thus be understood that such variations are within the scope of embodiments of the present invention.

### Additional Borrower Convenience and Protection Examples

The verification service provides advantages to the borrower in terms of privacy protection and also convenience. It will be understood that it is contemplated that convenience and protection to the borrower may be extended in additional ways to those previously described.

There are an increasing number of individuals that have accounts at two or more different financial institutions. Thus, it will be understood that it is contemplated that the service may include provisions to permit the verification service to check with each of the different financial institutions of a borrower. In this example, the borrower would be requested to provide access information for each of the borrower's financial institutions. For example, the borrower may have deposits and assets with one or more financial institutions, such as one or more banks, credit unions, or other financial accounts. In this example, the borrower may be provided with a user interface to provide authorization and access information to access all of the relevant accounts of the borrower.

Additionally, a lender may desire to check financial information over an extended time period to verify that a borrower is not a default risk. If a borrower has changed financial institutions, the service may include provisions to check with each of the different financial institutions over some time period required by the lender. As an example, suppose that the lender wants to verify financial information for the last two years. In this case the verification service may request the borrower to provide access information for each of the borrower's financial institutions for the last two years.

Individual financial institutions may maintain customer records for different lengths of time. In theory a financial institution could maintain records while a customer account is active. Thus records of financial institutions may include records going back in time for many years and/or have information not typically required in the lending process. For example, in theory a financial institution might maintain records going back many years. Additionally, the online records maintained by the financial institution might also contain more information than conventional financial statements used in the past by mortgage lender.

Typically, a lender legitimately needs to confirm assets and deposits to a degree necessary to verify that a borrower is not a default risk. This may include records demonstrating where a borrower has financial accounts, a minimum number of years the accounts have been opened for, and income information. However, it is possible that the financial records could include additional information not required by the lender due to the length of time the records are maintained and/or additional information. As examples, if a financial institution maintains “deep” financial information for many years, it is possible that such information could include information on financial transactions in the distant past. Some borrowers may be reluctant to disclose online financial information that implicitly contains such confidential information. The verification service may, in some embodiments, implement a data filtering policy to filter out from review any extraneous confidential information not required in the lending process as an additional form of privacy protection for a borrower.

Some financial institutions integrate financial information with confidential personal information of the customer. It will thus be understood that some borrowers might balk at providing access to such personal information without being provided a privacy protection policy to filter out sensitive information not relevant for a lender to make a lending decision.

It will thus be understood that a privacy protection policy may be included to protect sensitive confidential information that is integrated with the financial information that goes beyond the legitimate needs of a borrower. The privacy protection policy may also be implemented to prevent a lender discovering confidential information contrary to a government or industry policy.

It will thus be understood from these examples that a benefit of the present invention is that it may provide trusted filtering of the online financial records to protect the borrower's privacy needs while also making it extremely convenient for a borrower to provide the information that is necessary for the lender to make a lending decision.

### Additional Analytics of Assets and Deposits Examples

Lenders are interested in analyzing different aspects of financial statements for potential fraud. Deposit history may, for example, by analyzed over a given number of months (e.g., two months or six months) to verify both current assets, averages over different time periods, and to identify any suspicious deposit behavior, such as suddenly increasing deposits in the months immediately prior to taking out a loan request. Additionally, the deposit history may be analyzed for consistency with other financial information, such as payroll information and/or income information. It will be understood that in some embodiments the verification service may also perform one or more of these functions on behalf of a lender.

### Additional Embodiments Including Tax Income Information Verification

The present invention provides a technique to obtain assets and deposits information for making mortgage lending decisions. A technique to obtain tax information of a borrower is described in parent application U.S. patent application Ser. No. 14/103,455, which is incorporated by reference. It will be understood that the approach described in U.S. patent application Ser. No. 14/103,455 may be used in combination with the technique described in the present invention. First, it will be understood that a service may provide both types of information, e.g., both financial and tax information. Second, it will also be understood that in some embodiments the two types of information may be compared by the service as an additional anti-fraud measure such as by noting any discrepancies between the deposit and asset information and the tax information of the borrower, such as tax information on interest income from bank deposits.

Moreover, a technique to obtain payroll information of a borrower is described in application Ser. No. 14/150,581, which is incorporated by reference. Many borrowers are enrolled in direct deposit of payroll checks. Consequently, it will be understood that in some embodiments the payroll information may be compared with the deposit and asset information as an additional cross-check and anti-fraud measure.

Additionally, it will be understood that in some embodiments a lender may require all three types of information to make a lending decision and the borrower may be request to provide authorization to obtain each type of information. That is, it will be understood that the invention of the present application may be used in combination with the inventions describes in U.S. patent application Ser. Nos. 14/103,455 and 14/104,455. The underlying computer hardware, servers, interfaces, and security mechanisms are all compatible with each other such that the software modules can be integrated together in one system to provide a suite of services for the mortgage loan industry. A typical loan process requires verifying different types of financial information of a borrower, including tax records, payroll records, and deposit and asset information. Thus, it will be understood that in some embodiments a suite of services may be provided to aid a lender in making a lending decision.

### Additional Embodiments

While the invention has been described in conjunction with specific embodiments, it will be understood that it is not intended to limit the invention to the described embodiments. On the contrary, it is intended to cover alternatives, modifications, and equivalents as may be included within the spirit and scope of the invention as defined by the appended claims. The present invention may be practiced without some or all of these specific details. In addition, well known features may not have been described in detail to avoid unnecessarily obscuring the invention.

As previously discussed, the software modules to implement the above-described processes may be implemented on a variety of different computer systems. In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The methods of the present invention may also be tangibly embodied as a set of computer instructions stored on a computer readable medium, such as a memory device.

What is claimed is:

1. A computer implemented method for a lender to obtain assets and deposits information for making a mortgage lending decision without requiring the borrower to provide financial statements, comprising:
receiving, by a computer system, a request from a lender to obtain assets and deposits information for a borrower;
providing, by the computer system, a secure user interface for the borrower to enter information;
receiving, at the computer system, authentication information from the borrower, including information about the financial institution used by the borrower to access financial statements and access information, in the form of one or more of: login credentials used by the borrower to access their account with the financial institution, consent to allow the financial institution to release the financial statement to the interested party, and an interface or access protocol of the financial institution to release the financial statement to the interested party;
securely storing, by the computer system, the received authentication information in an encrypted format on a secure server according to a privacy protection protocol in order to protect the privacy of confidential information of the borrower;
obtaining, by the computer system, a copy of the electronic financial statement from the financial institution using the access information; and
generating, by the computer system, verified assets and deposits information for the borrower including:
securely transmitting to the lender, by the computer system, tamper-proof verified assets and deposits information of the borrower, including at least one of verified assets and deposits data and a verified financial statement; and
providing a certificate of authenticity to the lender.

2. A computer implemented method for obtaining financial statement information for making a lending decision without requiring a borrower to provide financial statements, comprising the steps of:
receiving, at a server computer, authentication information from the borrower, the authentication information including information to obtain financial statement information from a financial institution;
obtaining, by the server computer, the financial statement information from the financial institution;
generating, at the server computer, verified assets and deposits information from the financial statement information of the borrower; and
providing, by the server computer, the verified assets and deposits information to a lender.

3. The computer implemented method of claim 1, wherein the verified assets and deposits information includes at least one of a verified copy of the borrower's financial statement and a summary of the borrower's assets and deposits.

4. The computer implemented method of claim 2, further comprising converting the verified assets and deposits information in a tamper-proof form and providing the tamper-proof form to the lender.

5. The computer implemented method of claim 1, further comprising receiving a request from the lender for verified assets and deposits information and in response providing a user interface for the borrower to input the authentication information.

6. The computer implemented method of claim 1, wherein the authentication information includes the borrower's name, social security number, and the financial institution used by the borrower to access financial statements.

7. The computer implemented method of claim 1, wherein the authentication information includes login credentials of the borrower to access the borrower's account with the financial institution.

8. The computer implemented method of claim 1, wherein the authentication information includes the consent of the borrower.

9. The computer implemented method of claim 1, wherein the borrower has provided a written consent to release financial statement information to the lender.

10. The computer implemented method of claim 2, wherein the method is performed by a third party vendor.

11. The computer implemented method of claim 2, wherein the method is performed by the lender.

12. The computer implemented method of claim 2, wherein the method is performed by an agent of a financial institution.

13. A system for providing verified assets and deposits information to a lender without requiring a borrower to provide financial statements, comprising:
means for receiving information from a borrower applying for a loan including information about the borrower's financial institution;
means for receiving a borrower's authorization to obtain the borrower's financial statement from the financial institution and login credential information for the borrower's account with the financial institution;
means to protect the privacy of the borrower's confidential login credential information;
means to connect to the financial institution and retrieve the financial statement;
means to generate verified financial statement information; and
means to securely provide tamper proof assets and deposits verification to the lender, including at least one of verified assets and deposits data and a verified financial statement.

14. The system of claim 13, further comprising means to provide a certification of authenticity to the lender.

15. A system for providing verified assets and deposits information to a lender without requiring a borrower to provide financial statements, comprising:
a server computer including at least one processor, a memory, and having secure interfaces and firewall protection for communicating with a borrower, a lender, and a financial institution;
the system including computer program code residing on the memory to:
receive, at a server computer, authentication information from the borrower, the authentication information including information to obtain financial statement information from the borrower's financial institution;
obtain, by the server computer, the financial statement information from the borrower's financial institution;
generate, at the server computer, verified assets and deposits information from the financial statement information of the borrower; and
provide, by the server computer, the verified assets and deposits information to a lender.

16. The system of claim 15, wherein the verified assets and deposits information includes at least one of a verified copy of the borrower's financial statement and a summary of the borrower's assets and deposits.

17. The system of claim 15, wherein the server computer provides the verified assets and deposits information in a tamper-proof form to the lender.

18. The system of claim 17, wherein the server computer provide a certificate of authenticity to the lender.

19. The system of claim 15, wherein the authentication information from the borrower is securely stored according to a privacy protection protocol in order to preserve privacy of the authentication information.

20. The system of claim 15, wherein the server computer receives a request from the lender for verified assets and deposits information and in response providing a user interface for the borrower to input the authentication information.

21. The system of claim 15, wherein the authentication information includes the borrower's name, social security number, and information about the borrower's financial institution.

22. The system of claim 15, wherein the authentication information includes login credentials of the borrower to access the borrower's account with the financial institution.

23. The system of claim 15, wherein the authentication information includes the consent of the borrower.

24. The system of claim 15, wherein the system receives a request from the lender and in response sends a user interface link to the borrower for the borrower to enter the authentication information.
